(19) United States
(12) Patent Application Publication
(10) Pub. No.: US 2005/0138264 A1
(43) Pub. Date: Jun. 23, 2005

(54) Cache memory

(75) Inventor: Seiji Goto, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/046,890

(22) Filed: Feb. 1, 2005

Related U.S. Application Data
(63) Continuation of application No. PCT/JP03/02239, filed on Feb. 27, 2003.

(51) Int. Cl. G06F 12/08

(52) U.S. Cl. 711/3; 711/128; 711/202

(57) ABSTRACT

A cache memory is configured by a CAM, comprising a CAM unit for storing a head pointer indicating the head address of a data block being stored, the pointer map memory for storing a series of connecting relationships between pointers indicating addresses of data constituting a block and starting from the head pointer, and pointer data memory for storing data located by an address indicated by the pointer. The capability of freely setting the connection relationship of pointers makes it possible to set a block size arbitrarily and improves the usability of a cache memory.

### CROSS REFERENCE TO RELATED APPLICATION

This application is a continuation of international PCT application No. PCT/JP03/02239 filed on Feb. 27, 2003.

### BACKGROUND OF THE INVENTION

1. Field of the Invention

The present invention relates to structure of cache memory

2. Description of the Related Art

Instruction cache memory (i.e., a temporary memory for temporarily retaining instruction data from the main memory and alleviating a memory access delay) used by a processor mainly utilizes a direct map or N-way set associative method. These methods index cache by using access address as index (i.e., lower address bits corresponding to an entry number for a cache memory) to perform an identity decision for cache data by using a tag (i.e., memory address and working bits higher than the entry number for a cache memory). Note that the problem here is a reduced usability of a cache memory because a program having a specific index cannot reside in two or more cache (or, any more than (N+1)-number thereof in the N-way set associative method) at any given time.

FIG. 1 shows a conceptual configuration of cache memory using a direct map method of a conventional technique.

In a direct map cache memory, two-digit hexadecimal numbers (where 0x signifies a hexadecimal number; and indexes 00 through ff are given by the hexadecimal numbers in FIG. 1) are used for the index (i.e., address indicating the memory areas in a cache memory) and length of an entry represented by one index of cache memory is 0x40 bytes, that is, 64 bytes. Here, the lower two digits in the hexadecimal address of the main memory determines which cache entry should have the data having the address as shown in FIG. 1. For example, the data having the address of 0x0000 in main memory has the lower two-digit address of 00 and therefore will be stored in the entry indexed by 0x00 of the cache memory, whereas data having an address 80 for the lower two digits in main memory will be stored in the entry indexed by 0x02 of the cache memory. Consequently, it is not possible to store data having the respective addresses 0x1040 and 0x0040 in the cache memory since there is only one entry indexed by 0x01 as shown by FIG. 1, because the selection of the storage location is determined by the two lower digits of the main memory address. This will then force storage of either one in which case a caching error occurs when the processor calls the second data item of the above example described, requiring repeated access to the main memory.

FIG. 2 shows a conceptual configuration of conventional 2-way set associative cache memory.

In this case, the lower two digits of the main memory address determine which entry to store in a cache memory where two entries of the same index are allocated (which are called way 1 and way 2), reducing the possibility of causing a caching error as compared to the direct map cache memory. However, there is still a possibility of caching error since three or more data having the same lower two-digit address cannot be stored at the same time.

FIG. 3 shows a conceptual configuration of conventional content-addressable memory.

The use of content-addressable memory (“CAM” hereinafter) enables the same number of N-ways as the number of entries, solving the problem of usability, while creating the problem of higher cost due to an enlarged circuit.

The case of FIG. 3 is equivalent to a 256-way set associative cache memory. That is, if there are 256 pieces of data having the same lower two-digit address in main memory, all the data in the main memory can be stored in the cache memory. Accordingly, it is guaranteed that it will be possible to store data from the main memory in the cache memory, leaving no possibility of a caching error. Deploying a cache memory having the capacity to store all the data stored in the main memory, however, increases the complexity of hardware and associated control circuits, resulting in a high cost cache memory.

The configuration of the above described cache memory is described in the following published article:

“Computer Architecture” Chapter 8, “Design of Memory Hierarchy,” Published by Nikkei Business Publications, Inc; ISBN 4-8222-7152-8

FIG. 4 shows a configuration of the data access mechanism of a conventional 4-way set associative cache memory.

An instruction access request/address (1) from a program counter is sent to an instruction access MMU 10 and converted into a physical address (8), and then sent to cache tags 12-1 through 12-4 and cache data 13-1 through 13-4 as an address. If there is an upper bit address indicated by a tag output (i.e., tag) among those tag outputs searched by the same lower-bit address (i.e., index) which is identical with the request address by the instruction access MMU 10, then it indicates that there is valid data (i.e., a hit) in the cached data 13-1 through 13-4. These identity detections are performed by a comparator 15, and at the same time a selector 16 is started by the hit information (4). If there is a hit, the data is sent to an instruction buffer as instruction data (5). If there is no hit, a cache mis-request (3) is sent to a secondary cache. The cache mis-request (3) comprises a request itself (3)-1 and a mis-address (3)-2. Then, data returned from the secondary cache updates the cache tags 12-1 through 12-4 and the cache data 13-1 through 13-4, and likewise returns the data back to the instruction buffer. When updating the cache tags 12-1 through 12-4 and the cache data 13-1 through 13-4, write-address (7) is outputted from the instruction access MMU 10. The update of the cache tags 12-1 through 12-4 and the cache data 13-1 through 13-4 is executed by a tag update control unit 11 and a data update control unit 14. In an N-way configuration, the comparator 15 and the selector 16 have N-number of inputs, respectively. Meanwhile, a direct map configuration requires no selector.

A technique is disclosed in a Japanese patent laid-open application publication 11-328014 in which a block size is suitably set for each address space as a countermeasure to a difference in extension of spatial locality in the respective address spaces in an attempt to improve the usability of cache memory.

Another technique is disclosed in a Japanese patent laid-open application publication 2001-297036 for equipping a RAM set cache which can be used with the direct map method or the set associative method. The RAM set cache is configured so as to comprise one way in the set associative method and performs read/write a line at a time.

### SUMMARY OF THE INVENTION

The object of the present invention is to provide a low cost, highly usable cache memory.

A cache memory according to the present invention comprises a head pointer store unit for storing a head pointer corresponding to a head address of a data block being stored; a pointer map store unit for storing a pointer corresponding to an address being stored with data constituting the data block and connection relationships between the pointers starting from the head pointer; and a pointer data store unit for storing data stored in an address corresponding to the pointer.

According to the present invention, data is stored as blocks by storing the connecting relationships of pointers. Therefore, storing variable length data blocks is enabled by changing the connecting relationships of the pointers.

That is, it is possible to consume the capacity of cache memory effectively to its maximum and respond flexibly to cases in which storing a mixture of large and small blocks of data is required as compared to conventional methods in which a unit for data block to be stored is predetermined. This makes it possible to improve the efficiency of cache memory, resulting in a lower probability of caching errors.

### BRIEF DESCRIPTION OF DRAWINGS

FIG. 1 shows a conceptual configuration of cache memory using a conventional direct map method;

FIG. 2 shows a conceptual configuration of conventional 2-way set associative cache memory;

FIG. 3 shows a conceptual configuration of conventional content-addressable memory;

FIG. 4 shows a configuration of the data access mechanism of a conventional 4-way set associative cache memory;

FIGS. 5 and 6 describe a concept of the present invention;

FIG. 7 shows an overall configuration including the present invention;

FIG. 8 shows a configuration of an embodiment according to the present invention;

FIG. 9 shows a configuration of a case in which the page management mechanism of an instruction access MMU of a processor and a CAM are shared;

FIGS. 10 through 13 describe operations of the embodiments according to the present invention.

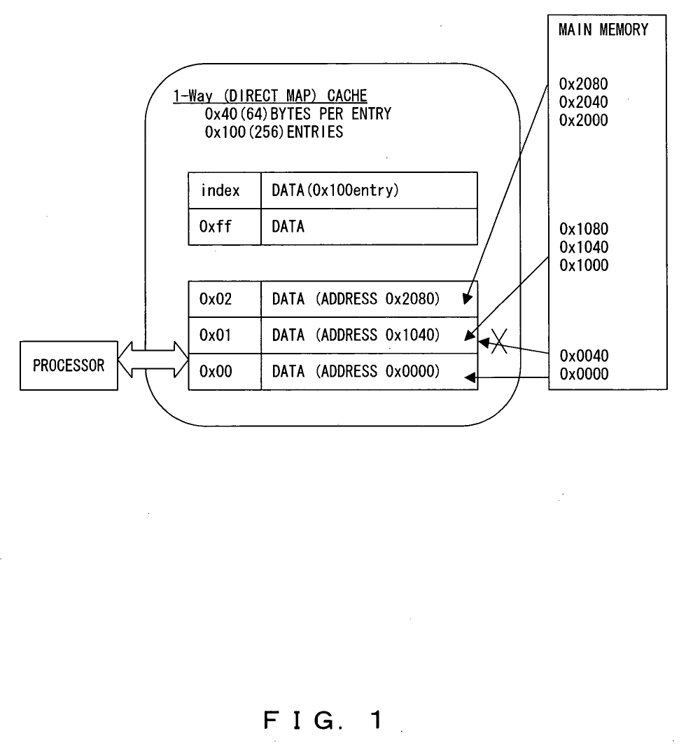

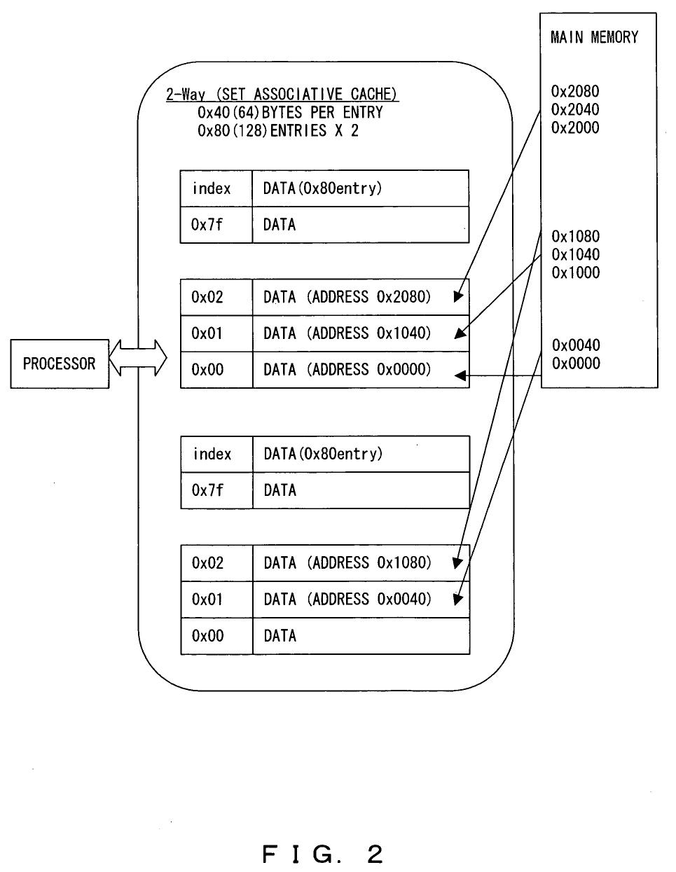

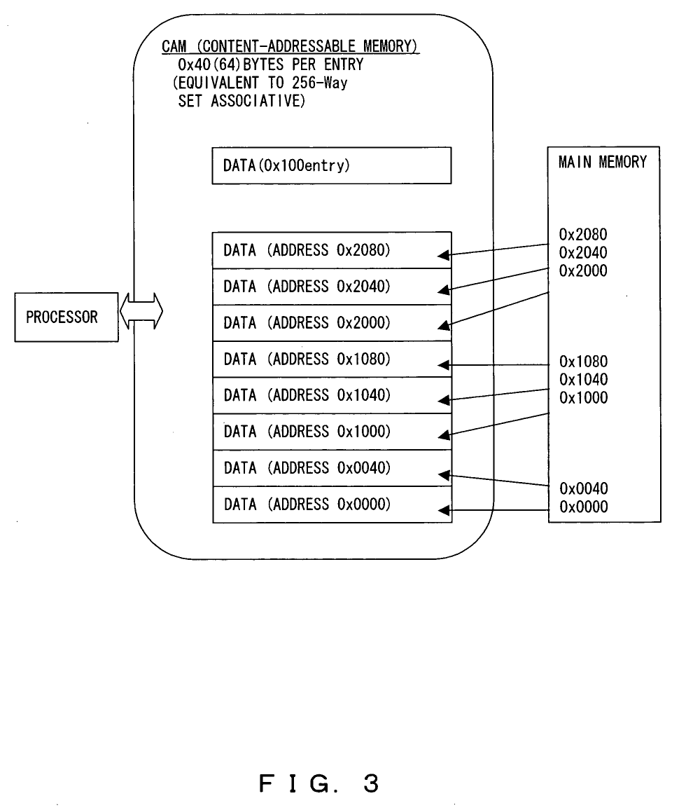

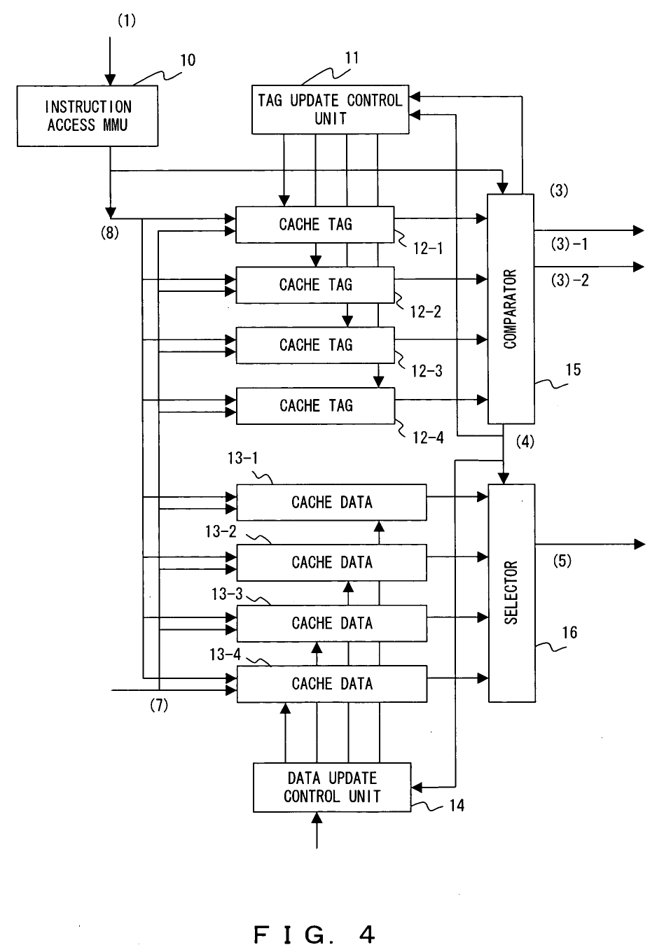

### DESCRIPTION OF THE PREFERRED EMBODIMENTS

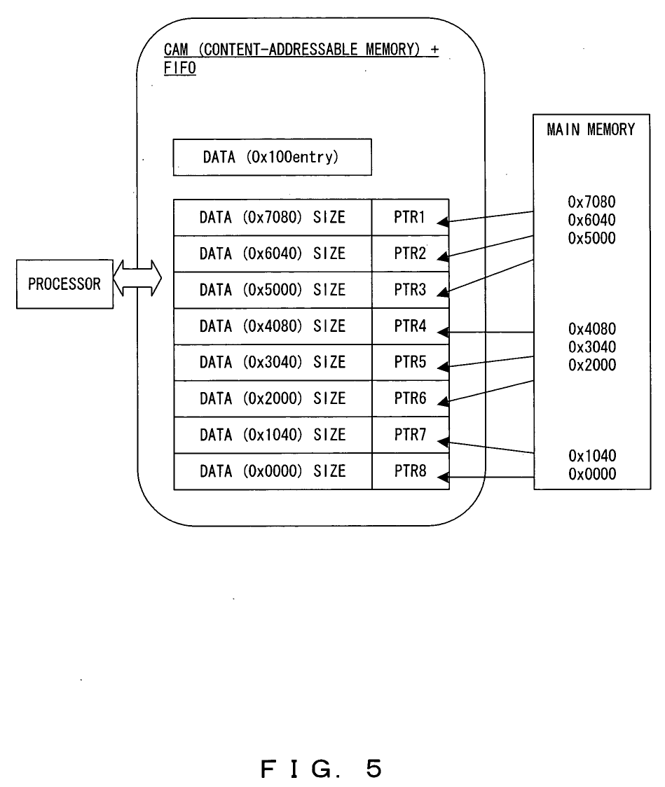

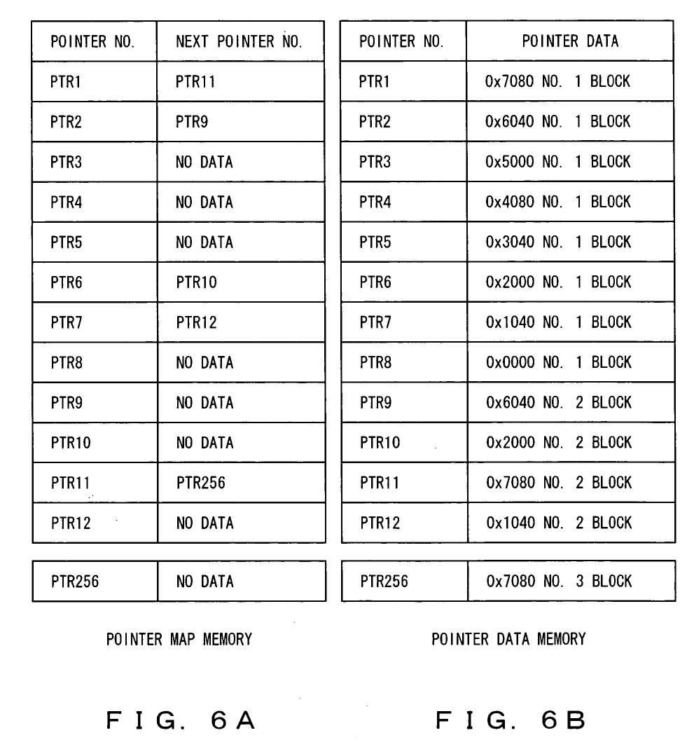

FIGS. 5 and 6 describe a concept of the present invention.

The present invention has focused on the fact that instruction executions by a processor are largely done not by one entry of a cache but by a number of blocks, tens of blocks or more, thereof. The problem would have been solved by applying the CAM for all entries, had it not caused a high cost, as described above. Accordingly, the CAM is applied to each instruction block, not cache entry. Specifically, only information on a certain instruction block (i.e., head address, instruction block size and number for the head pointer of the instruction block) is retained on the CAM (refer to FIG. 5). The instruction data itself is stored in a FIFO-structured pointer memory indicated by the head pointer (refer to FIG. 6). The pointer memory comprises two memory units, i.e., a pointer map memory and a pointer data memory where the former contains connection information and the latter contains the data itself in the pointer, enabling a plurality of FIFO to be virtually built in memory. That is, while the memory area is a continuous area like RAM, a continuity of data is actually maintained by retaining the connection information in the pointers. Therefore, the data indicated by a pointer having continuity constitute one block, resulting in storage by block in a cache memory of the present embodiment according to the invention. Note here that a cache memory of the present embodiment according to the invention makes it possible to change the block size of stored data by manipulating the connection information of the pointer. That is, there is no such thing as a plurality of physical FIFO being made up.

Reading in an instruction cache according to the present invention is performed in the steps of: (1) acquiring a pointer being stored with the head address of a block containing data to be accessed by indexing a CAM from the address; (2) acquiring a pointer for a block containing data to be accessed from the pointer map memory; (3) reading in instruction data to be accessed from the instruction data block indicated by the pointer obtained from the pointer data memory; and (4) execution. This makes it possible to gain the same usability of a cache memory as one which is equipped with data memory areas having different length per instruction blocks. Meanwhile, the circuit is relatively compact since there is less search information as compared to using the CAM for all entries. In case a cache error occurs, a spare pointer supply unit (not shown) supplies a spare pointer for writing data from the memory in an entry of the pointer memory indicated by the spare pointer at the time of setting a tag in the CAM. In the case that the processor instructs a continuous access, a spare pointer is supplied again, likewise it is written in the cache and a second pointer is added to the pointer queue. In the case of using up all the pointers, a cancel instruction frees blocks by scrapping older data to secure spare pointers.

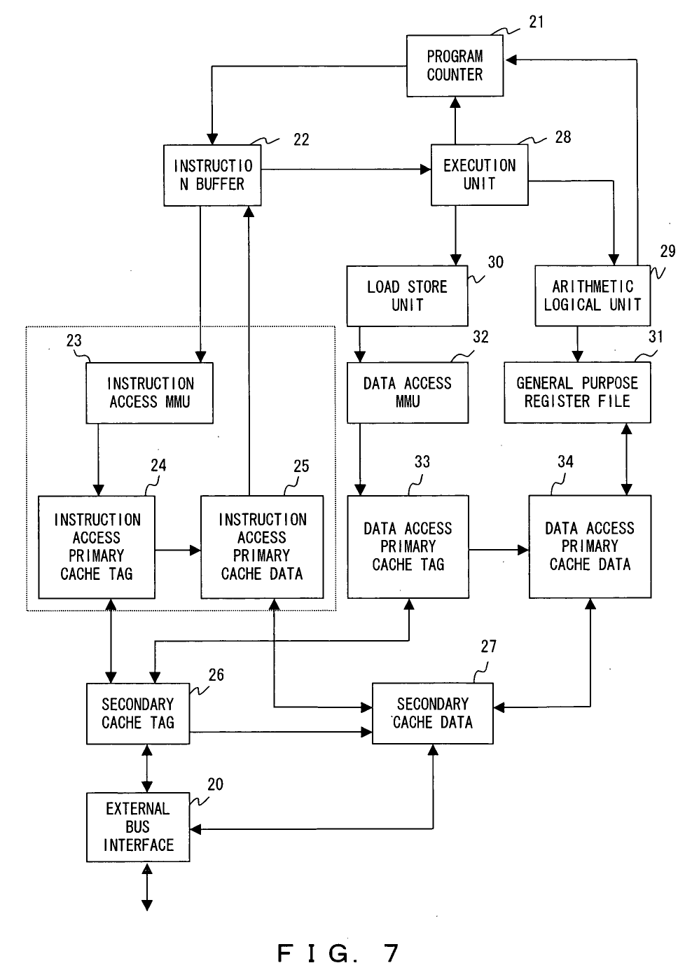

FIG. 7 shows an overall configuration including the present invention.

FIG. 7 illustrates a micro processor, operating as follows.

1) Instruction Fetch

Obtain an instruction for execution from an external bus by way of an external bus interface 20. First, check whether or not an instruction pointed to by a program counter 21 exists in an instruction buffer 22, and if not, the instruction buffer 22 sends a request for an instruction fetch to an instruction access MMU 23. The instruction access MMU 23 converts logical addresses being used by the program into physical addresses, being dependent on the mapping order of the hardware. Search the instruction access primary cache tag 24 by using the address, and if coincidence is found, send a read-out address and return the instruction data back to the instruction buffer 22, since there is the target data in the instruction access primary cache data 25. While if coincidence is not found, search further in a secondary cache tag 26, and on further failure to obtain a hit, issue a request to an external bus for instance, and supply returned data to a secondary cache data 27 and the instruction access primary cache data 25, sequentially. At this time, flag that the data has been supplied by updating the secondary cache tag 26 and the instruction access primary cache tag 24. Store the supplied data in the instruction buffer 22 in the same manner as when existing in the instruction access primary cache data 25.

2) Instruction Execution

A row of instruction stored in the instruction buffer 22 is sent to an execution unit 28 and transmitted to an arithmetic logical unit 29 or a load store unit 30 corresponding to the respective instruction types. The process includes recording outputs of the arithmetic logical unit 29 in a general purpose register file 31, or updating a program counter (not shown), for an operation instruction and a branch instruction. While for a load store instruction, a load store unit 30 accesses to a data access MMU 32, a data access primary cache tag 33 and a data access primary cache data 34 sequentially as in the instruction access, and execute according to the instruction such as load instruction for copying the data in the general purpose register file 31 or a store instruction for copying from the general purpose register file 31. If there is no instruction data in the primary cache, obtain data either from the secondary cache being commonly used by an instruction execution body or an external bus and execute likewise. After the execution, the program counter is sequentially incremented or changed to a branch instruction address, and the processing goes back to the above 1) instruction fetch.

3) Overall

As described above, while the microprocessor operates by repeating the instruction fetch and the instruction execution, the present invention provides a new configuration as enclosed by the dotted lines in FIG. 7, i.e., the instruction access MMU 23, the instruction access primary cache tag 24 and the instruction access primary cache data 25.

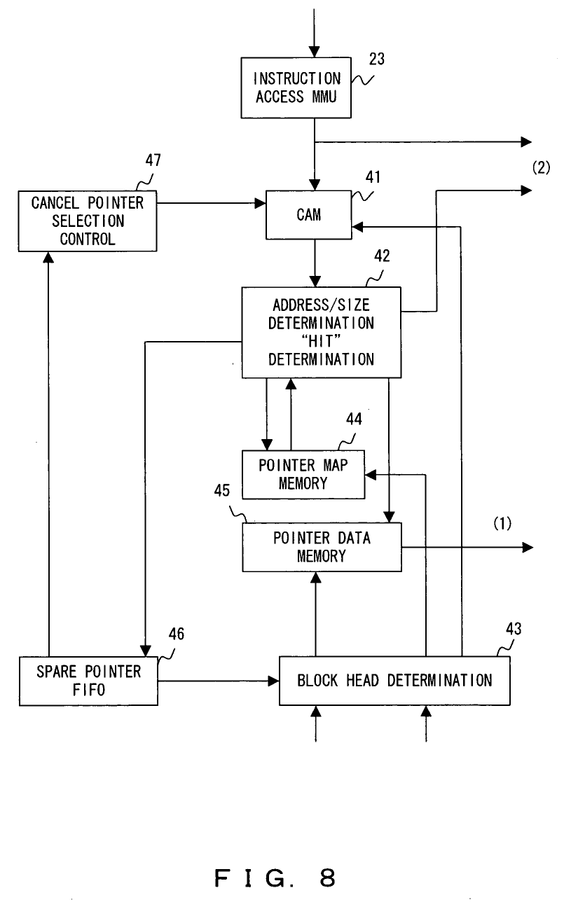

FIG. 8 shows a configuration of an embodiment according to the present invention.

An instruction access request/address from the program counter is sent to the instruction access MMU 23, converted into a physical address and then sent to a CAM 41 as an address. The CAM 41 outputs a tag, a size and head pointer data. An address and size determination/hit determination block 42 searches for final required pointer, and if there is one, the pointer data is read out and sent to an instruction buffer (not shown) as instruction data (1). While if there is not, then a cache mis-request (2) is outputted to the secondary cache. Then, data returned from the secondary cache goes by a block head determination block 43 and, if it is a head instruction, updates the CAM 41, while if not a head instruction, updates the pointer map memory 44 and the CAM size information 42 and additionally updates the pointer data memory 45, finally returning the data to the instruction buffer. In the block head determination block 43, a spare pointer is supplied by a spare pointer FIFO 46 at the time of writing in. If all the spare pointers have been used up, then an instruction is output by the spare pointer FIFO 46 to the cancel pointer selection control block 47 for a cancel instruction for a discretionary CAM entry. The output is invalidated by the address and size determination/hit determination block 42 to be returned to the spare pointer FIFO 46.

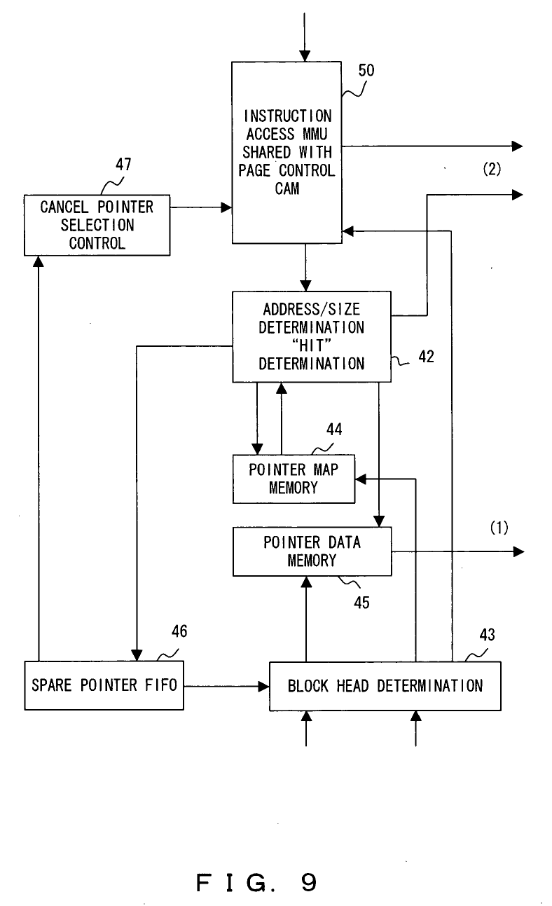

FIG. 9 shows the configuration of a case in which a page management mechanism of an instruction access MMU of a processor and a CAM are shared.

Note that the components common to FIG. 8 are assigned the same reference numbers in FIG. 9, and their descriptions are omitted here.

This configuration sets a unit of address conversion (i.e., page) in the MMU of the same size as that of managing a cache for making the CAM in the MMU have the same function, thereby acting to reduce the CAM (refer to 50 in FIG. 9). That is, while the instruction access MMU has a table for converting a virtual address into a physical address, merging the table and the CAM table into one so as to enable the instruction access MMU mechanism to operate a CAM search, et cetera. This makes it possible to handle a search mechanism for the table by sharing hardware between the instruction access MMU and CAM search mechanism, thereby eliminating hardware.

Meanwhile, a program has to be read in by blocks, since instruction data to be read in is stored by blocks in the present embodiment according to the invention. In this case, if the instruction determines that the read-in data is a subroutine call and its return instruction, a conditional branch instruction or exception processing and its return instruction at the time of the processor completing reading in the data, it is stored in the cache memory in units of blocks between the instructions, by determining that it is either the head or end of program. As such, although the block size will be different for every read-in data in the case of a cache memory reading in the read-in instruction in blocks responding to the content of a program, the present embodiment according to the invention makes it possible to adopt such a method by constructing variable size blocks in memory through the use of pointers. It is also possible to contrive an alternative method of predetermining a block size forcibly, by placing a discretionary instruction at the head of a block at the time of decoding a program instruction sequentially and defining a last instruction as the last instruction being included in the block at the time of making the block the predetermined size. In this case, merely changing an instruction decode for the block head determination shown in FIGS. 8 and 9 enables the adoption of making such discretionary blocks. For instance, a decision for a block head is made possible by determining a call instruction and/or a register write instruction in the case of making a block according to a description of program.

In the present embodiment according to the invention, a processor detects the head and end of an instruction block and transmits a control signal to the instruction block CAM. The control mechanism, upon receiving a head signal, records a cache tag, obtains data from the main memory and writes the instruction in the cache address indicated by the pointer. A spare entry is supplied from the spare pointer queue and the entry number is added to the cache tag queue every time the processor request reaches a cache entry, and, additionally, the instruction block size is added up. When branching to the same block multiple times or in the middle of a block, an entry number is extracted from the cache tag and the cache size for accessing. Also in the above described, the head and end of an instruction block are reported by a specific register access. In this case, an instructed explicit start/end of block must be declared. This is required for the case in which blocks are written using discretionary pointers as described above, not by an instruction included in a program.

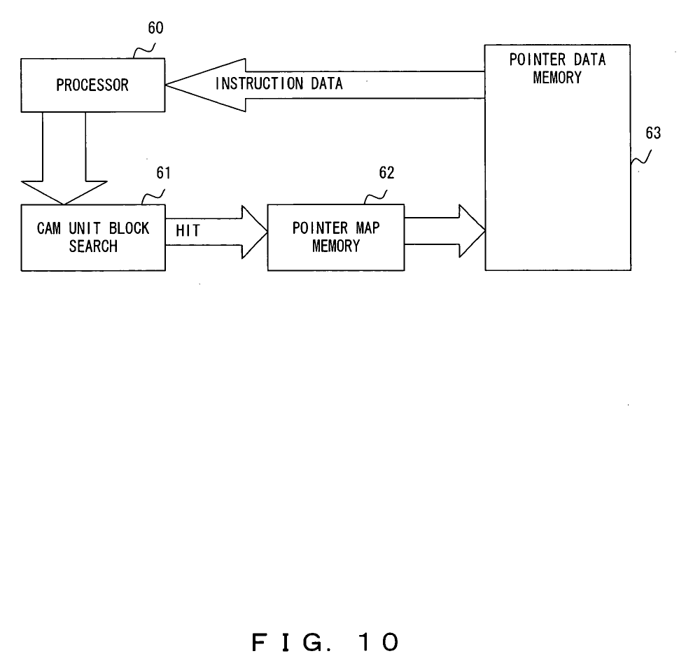

FIGS. 10 through 13 describe operations of the embodiments according to the present invention.

FIG. 10 shows an operation when an instruction exists, i.e., an instruction hit, in cache memory according to the present embodiment of the invention.

When the address of instruction data to be accessed is output by a processor 60, the head pointer of a block containing the instruction data to be accessed is searched in a CAM unit 61. If the head pointer of a block containing the instruction data to be accessed exists, it is an instruction hit. Pointer map memory 62 is searched by using the obtained head pointer, and all the pointers of the instruction data constituting the block are obtained. The instruction data is obtained from pointer data memory 63 by using the obtained pointers and returned to a processor 60.

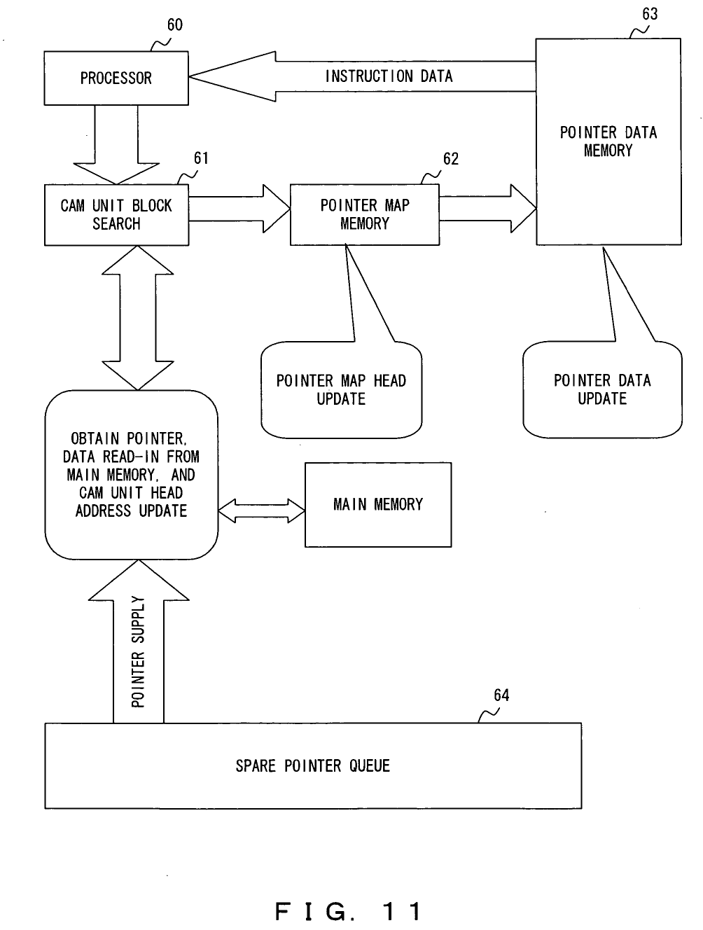

FIG. 11 shows a case in which an instruction does not exist, (i.e., an instruction mis-hit), the instruction to be accessed is supposed to be at the head of a block, in cache memory according to the present embodiment of the invention.

In this case, an address is specified by the processor 60 and access to instruction data is tried. Although a pointer is searched in the CAM unit 61 according to the address, it is determined that there is no block containing a corresponding instruction and it is also determined that the corresponding instruction is supposed to be at the head of the block. In this case, a spare pointer is obtained from a spare pointer queue 64, a block containing the aforementioned instruction data is read in from the main memory and the head address indicated by the head pointer of the CAM is updated. Then the instruction data will be returned to the processor 60 with pointer map memory 62 correlating the obtained spare pointer with the block and pointer data memory 63 linking each pointer with a respective instruction data read in from the main memory. The spare pointer queue 64 is a pointer data buffer structured as a common FIFO and its initial value is for recording pointers between zero and the maximum.

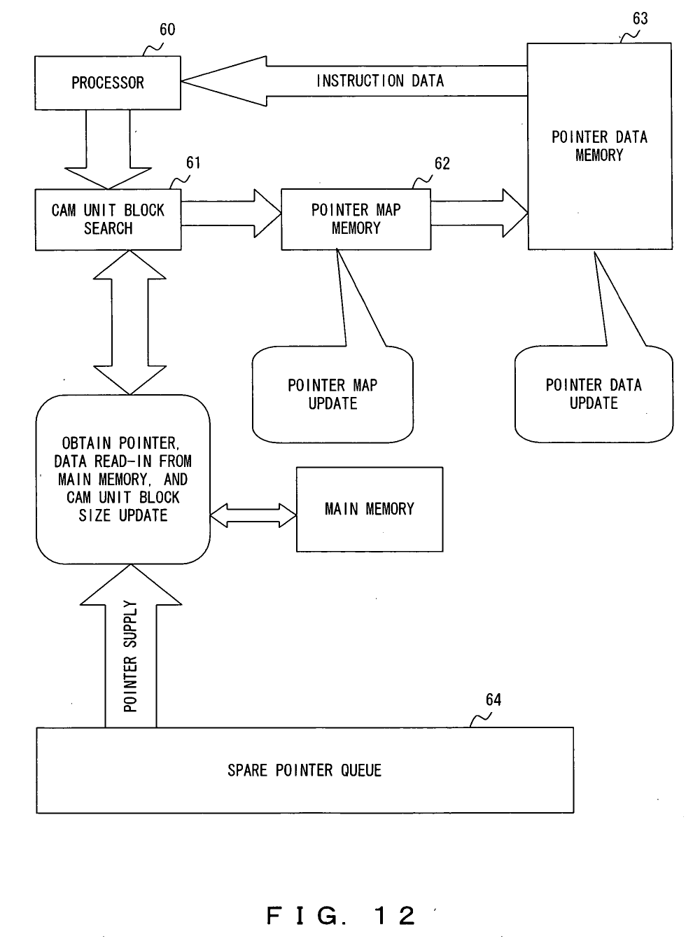

FIG. 12 shows an operation of a case in which instruction data does not exist, and instruction data is supposed to be located in a position other than the head of a block, in cache memory according to the present embodiment of the invention.

An address is output by the processor 60 and instruction data is searched in the CAM unit 61, but the determination is that it is not in the cache memory. A spare pointer is obtained from the spare pointer queue 64 and a block containing the aforementioned instruction data is read in from the main memory. A block size in the CAM unit 61 is updated in a manner such that the read-in block is connected with the one adjacent to the aforementioned block and registered already in the CAM unit 61, the pointer map memory 62 is updated, the instruction data contained in the read-in block is stored by the pointer data memory 63 and the instruction data is returned to the processor 60.

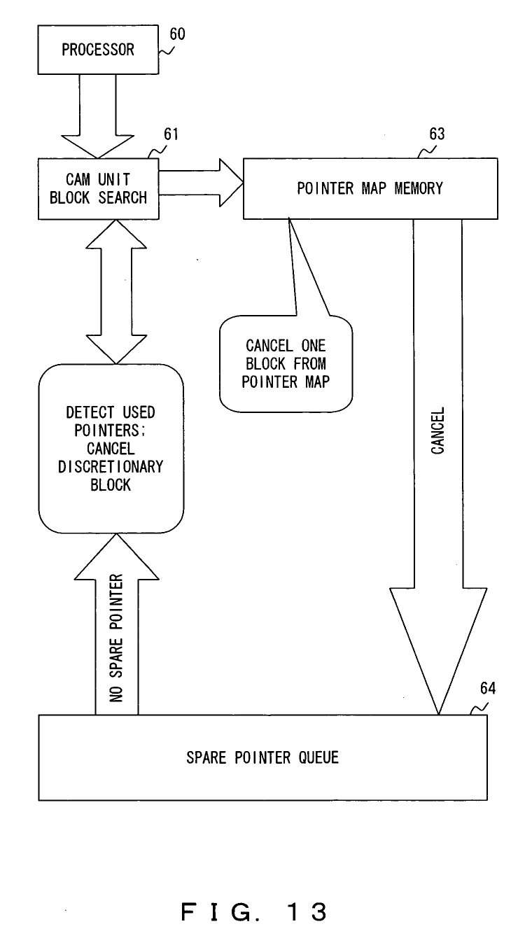

FIG. 13 is an operation of a case in which a block containing an instruction data should be cached but there is no spare pointer.

The processor 60 accesses the CAM unit 61 for an instruction data. However, the determination is that the instruction data does not exist in the cache memory. Furthermore, an attempt to obtain a spare pointer from the spare pointer queue for reading in the instruction data from the main memory is met by an instruction for canceling a discretionary block because all the pointers have been used up. The pointer map memory 62 cancels a pointer for one block from the pointer map and reports the canceled pointer to the spare pointer queue 64. The spare pointer queue 64, thus obtaining the spare pointer, reports it to the CAM unit 61 and enables it to read in new instruction data from the main memory.

A cache memory according to the present invention makes it possible to provide a cache memory structure capable of substantially improving the usability of a cache by reducing circuit complexity in comparison to using a CAM comprised cache memory.

1. A cache memory, comprising:
a head pointer store unit for storing a head pointer corresponding to a head address of a data block being stored;
a pointer map store unit for storing a pointer corresponding to an address being stored with data constituting the data block and connection relationships between the pointers starting from the head pointer; and
a pointer data store unit for storing data stored in an address corresponding to the pointer.

2. The cache memory in claim 1, wherein said data block is a series of data with its head and end being defined by an instruction from a processor.

3. The cache memory in claim 1, wherein said data block is a series of data with its head and end being defined by a result of decoding an instruction contained in a program.

4. The cache memory in claim 3, wherein said instruction is a subroutine call and its return instruction, a conditional branch instruction, or an exception handling and its return instruction.

5. The cache memory in claim 1, wherein said head pointer store unit stores by correlating the head address of said data block and the data block size with said head pointer of the data block.

6. The cache memory in claim 1, wherein said head pointer store unit is a store unit by adopting a content-addressable memory method.

7. The cache memory in claim 1, further comprising a spare pointer queue unit for retaining a spare pointer, wherein
a spare pointer indicated by the spare pointer queue unit is used when a need for storing new data block arises.

8. The cache memory in claim 7, wherein a spare pointer is produced by canceling one of data blocks currently being stored if said spare pointer queue unit does not retain a spare pointer when a need for storing new data block arises.

9. The cache memory in claim 8, wherein said canceling is done from older data block.

10. The cache memory in claim 1, wherein a processor stores a new data block being headed by data which is to be accessed to by the processor if data to be accessed by the processor is not stored and the data is to be at the head of a data block.

11. The cache memory in claim 1, wherein a processor stores a new data block containing data which is to be accessed to by the processor in a manner to connect with another one already stored if data to be accessed by the processor is not stored and the data is other than one to be located at the head of a data block.

12. The cache memory in claim 1, wherein data stored by said head pointer store unit is managed together with data retained by a conversion mechanism which converts a virtual address issued by a processor into a physical address.

13. The cache memory in claim 1, wherein said data is an instruction data.

14. A control method for cache memory, comprising:
storing a head pointer for storing a head pointer corresponding to a head address of a data block being stored;
storing a pointer map for storing a pointer corresponding to an address being stored with data constituting the data block and connection relationships between the pointers starting from the head pointer; and
storing pointer data for storing data stored in an address corresponding to the pointer, wherein
storing variable length of data blocks are enabled.

15. A cache memory control apparatus, comprising:
a head pointer store unit for storing a head pointer corresponding to a head address of a data block being stored;
a pointer map store unit for storing a pointer corresponding to an address being stored with data constituting the data block and connection relationships between the pointers starting from the head pointer; and
a pointer data store unit for storing data stored in an address corresponding to the pointer.
